(19) United States
(12) Patent Application Publication
(10) Pub. No.: US 2018/0077095 A1
(43) Pub. Date: Mar. 15, 2018

(54) Augmentation of Communications with Emotional Data

(71) Applicant: X Development LLC, Mountain View, CA (US)

(72) Inventors: Travis Deyle, San Jose, CA (US); Eric HC Liu, Redwood City, CA (US)

(21) Appl. No.: 14/853,816

(22) Filed: Sep. 14, 2015

(51) Int. Cl. H04L 12/58; G06F 17/27; G10L 13/027; G10L 25/63; G06T 13/80; G06T 13/40; G06T 13/20; G06K 9/00; G06F 17/24

(52) U.S. Cl. CPC H04L 51/10; G06F 17/2785; G10L 13/027; G10L 25/63; G06F 17/241; G06T 13/40; G06T 13/205; G06K 9/00302; G06K 9/00369; G06T 13/80

(57) ABSTRACT

A sender device may receive input data including to at least one of text or speech input data during a given period of time. In response, the sender device may use one or more of the emotion detection modules to analyze input data received during the same period of time to detect emotional information in the input data, which corresponds to the textual or speech input received during the given period of time. The sender device may generate a message data stream that includes both: text generated from the textual or speech input during the given period of time, and emotion data providing emotional information the same period of time. A recipient device may then use one or more emotion augmentation modules to process such a message data stream and output an emotionally augmented communication.

### BACKGROUND

Unless otherwise indicated herein, the materials described in this section are not prior art to the claims in this application and are not admitted to be prior art by inclusion in this section.

The true meaning of spoken words can often vary according to speaker's emotions while speaking. As such, emotional information that is observed by the recipient of spoken words can add to or change the meaning of the words. For instance, the inflection of a speaker's voice, and a speaker's non-verbal gestures and facial expressions, can all add to and significantly change the meaning of spoken words. Computer-based communications such as text messages, e-mails, and text-to-speech generated messages can often lose meaning because they fail to properly convey emotional information corresponding to the actual speech from which the message was generated.

Modern computing device users have developed some ways to manually add emotional information to computer-based communications. For example, emoticons are commonly used in conjunction with text to express emotions related to the text. Emoticons such as “smiley” and “frowny” faces are typed using existing symbols and letters, and in some cases are recognized by the application in which they are entered and converted into graphic emoticons (e.g., “:)” may be converted to a graphic of a smiling face, and “:(” may be converted to a graphic of a frowning face. Other examples also exist.

### SUMMARY

Current emoticon recognition is limited because it typically requires the user to manually write or speak symbols to specify when and where an emoticon should be included. Such entry of emoticons may be perceived as unnatural and can slow down the process of creating and sending a message. Accordingly, example embodiments may help to automatically detect emotional information that accompanies speech and/or textual input to a computing device and associate such emotional information with textual and/or speech messages that are sent as a result of such input. For example, a text message application may use a facial-expression recognition process to image(s) of a user's face that is captured while the user is typing a text message, and may thereby determine the person's emotional state while typing the message. An emoticon indicating the emotions surrounding the text message could then be automatically selected and inserted into the text message. Other examples and variations on the above example are also possible.

In one aspect, an example computing device may include: a communication interface, one or more input devices, at least one processor, and one or more emotion detection modules, wherein each emotion detection module comprises program instructions stored on a non-transitory computer readable medium and executable by the at least one processor. Further, computing device may include program instructions stored on a non-transitory computer readable medium and executable by the at least one processor to: (a) receive input data comprising to at least one of text input data or speech input data from one or more of the input devices, wherein the input data comprising at least one of text input data or speech input data is received during a given period of time; (b) in response to receipt of the at least one of text input data or speech input data, use one or more of the emotion detection modules to analyze input data received from at least one of the one or more input devices, during the given period of time, to detect emotional information corresponding to the textual or speech input received during the given period of time; (c) generate a message data stream comprising (i) a communication based on the at least one of the textual or speech input during the given period of time, and (ii) emotion data based on the corresponding emotional information the given period of time; and (d) operate the communication interface to transmit the message data stream.

In another aspect, an example computing device may include: a communication interface, one or more input devices, at least one processor, and one or more emotion augmentation modules, wherein each emotion augmentation module comprises program instructions stored on a non-transitory computer readable medium and executable by the at least one processor. Further, computing device may include program instructions stored on a non-transitory computer readable medium and executable by the at least one processor to: (a) receive a message data stream comprising (i) a communication based on at least one of the textual or speech input at another computing device during the given period of time, and (ii) emotion data indicative of emotional information corresponding to receipt of the textual or speech input at another computing device, during the given period of time; and (b) use one or more of the emotion augmentation modules to generate an emotionally augmented communication based on the emotion data and the received communication based on at least one of the textual or speech input; and (c) output the emotionally augmented communication via at least one of the output devices.

In a further aspect, an example method may involve a computing device: (a) receiving input data from one or more input devices of the computing device, wherein the input data received during a given period of time comprises to at least one of text input data or speech input data; (b) in response to receiving the at least one of text input data or speech input data, the computing device analyzing input data received from at least one of the one or more input devices, during the same period of time, to detect emotional information corresponding to the textual or speech input received during the same period of time; (c) generating a message data stream comprising (i) a communication based on the at least one of the textual or speech input during the given period of time, and (ii) emotion data based on the corresponding emotional information the given period of time; and (d) transmitting the message data stream to a recipient.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a block diagram illustrating a communication system in which example embodiments may be implemented.

FIG. 2A is a functional block diagram illustrating devices, systems, and functional components, in which example embodiments may be implemented.

FIG. 2B is another functional block diagram illustrating devices, systems, and functional components, in which example embodiments may be implemented.

FIG. 3 is a flow chart illustrating a method according to an example embodiment.

FIG. 4 is a simplified block diagram of a computing device according to an example embodiment.

### DETAILED DESCRIPTION

Example methods and systems are described herein. It should be understood that the words “example” and “example” are used herein to mean “serving as an example, instance, or illustration.” Any embodiment or feature described herein as being an “example” or “example” is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

### I. Overview

As noted above, example embodiments may help to automatically detect emotional information that accompanies speech and/or textual input to a computing device and associate such emotional information with textual and/or speech messages that are sent as a result of such input.

For example, an e-mail or text message application may apply a facial-expression recognition process to image data of the user's face that is captured during the same period of time that the user is typing or providing speech to a speech-to-text process. The facial-expression recognition process may indicate a certain emotional state or states (e.g., a particular emotion, a sequence of emotions, or multiple simultaneous emotions) that existed while the user was typing or speaking, and use these to automatically determine an appropriate emoticon. This emoticon may then be added to the text that was typed by the user (or that was generated from the user's speech by a speech-to-text process). Alternatively, emotional data indicating the associated emotional state may be included as metadata in a message including the text that was typed in by the user. by recognizing a user's emotional cues while inputting text on a smartphone, the smartphone may annotate text input data with corresponding emotion metadata, which can then be used in various ways when the text is converted into another form (e.g., such as a text message or e-mail). As such, the emotion accompanying a text-based communication can be conveyed to recipient who is unable to observe the sender's emotional cues in person.

Example embodiments may be useful in various scenarios. As one specific example, consider a scenario where text messages (e.g., SMS or MMS messages) are being exchanged between two people, Jane and Matt. Jane may be driving her car, and may dictate a text message via her car's Bluetooth kit, which is connected to her mobile phone (or perhaps via car computing system that is configured for cellular communications). Specifically, Jane may speak the following message, which can be converted to text using a speech-to-text process: “I can't believe you got tickets. I am so angry at you.” However, Jane is laughing as she speaks.

Jane's laughter may be detected in audio that is captured by a microphone in her mobile phone or car computing system, and/or in image data (e.g., video) captured by her mobile phone's camera or a driver-facing camera in her car. Since laughter is detected in conjunction with dictation of the text message, emotion metadata indicative of laughter may be created and associated with the text that is output from the speech-to-text process. Jane's mobile phone or car computing system may then use this emotion metadata to augment the speech data; e.g., by automatically inserting an emoticon indicative of laughter at the end of the text message that is sent to Matt, or by inserting emotional text information at the end of the text message (e.g., “(laughing)” or “**laughing**”). As such, when Matt looks at the text message on his phone, the text message may read: “I can't believe you got tickets. I am so angry at you :-)” or “I can't believe you got tickets. I am so angry at you (laughing)”, among other possibilities. In any such case, because emotional metadata is used to augment the text message, Matt can easily understand that Jane is not really angry with him, regardless of what the plain meaning of Jane's words might be.

More generally, an example method may involve a computing device receiving input data from one or more input devices during a period of time, where the input data received from at least one of the input devices during the period of time comprises to at least one of textual or speech input. The computing device may then analyze the input data received from at least one the input devices during the period of time, to determine emotional information corresponding to the textual or speech input received during the same period of time. The computing device may then generate a data message that includes: (i) a communication based on the at least one of the textual or speech input and (ii) emotion data based on the determined emotional information. The data message may then be transmitted to a recipient account (e.g., to another computing device associated with the recipient's user account).

### II. Illustrative Communication Devices and Systems

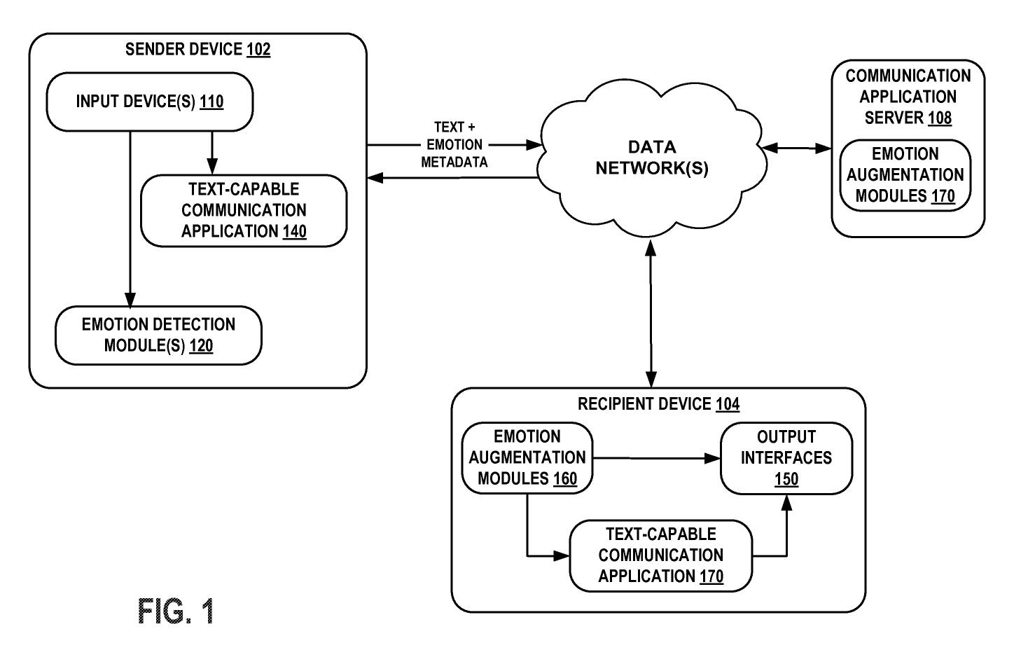

FIG. 1 is a functional block diagram illustrating a communication system in which example embodiments may be implemented. The system shown in FIG. 1 includes a sender device 102, which may be any computing device that facilitates text-based or speech-based communications, such as a mobile phone (e.g., a smartphone), a tablet, a laptop computer, a car computing system, or a wearable computing device, among other possibilities. The sender device 102 may be operable to send a text-based communication and associated emotion metadata to a recipient device 104 via a network 106 (or possibly multiple interconnected networks). The recipient device 104 may also be any computing device that facilitates text-based or speech-based communications. Further, sender device 102 and recipient device 104 may be the same type of device, or may be different types of devices.

As shown, sender device 102 includes one or more input devices 110, which may be operable to receive user input and/or to capture emotional information. At least one of the input devices 110 allows for entry or dictation of text, which may be provided to a text-based communication application 120 (e.g., an e-mail or text message application). The text-based communication application 120 may allow for text-based communications to be sent to (and perhaps received from) one or more recipient devices 104. Such communications may optionally be supported by a communication application server 108 (e.g., and e-mail, SMS, or MMS server), or possibly by multiple servers.

Sender device 102 also includes emotion detection module(s) 120. These modules receive input data from one or more of input devices 110, and are configured to analyze the received input data to detect emotional information corresponding to the user's emotional state while providing input data (e.g., text or speech) to the text-based communication application 130. Such modules may accordingly output emotion data that is indicative of a user's emotion state while providing text to communication application 120. Note also that while emotion detection module(s) 120 are shown in FIG. 1 as being separate from the sender device's text-capable communication application 140, one or more of the emotion detection modules 120 may in fact be part of text-capable communication application 140, or part of another communication application implemented on the sender device.

In some implementations, each emotion detection module 120 may act, in a sense, as a filter and/or formatter for input data, which identifies and/or characterizes portions of input data from one or more input devices 110 as providing “emotional information;” or in other words, as being data that is potentially informative about a user's emotional state. In such an implementation, the analysis and/or interpretation of such potential emotional information to determine a particular emotion or emotions that are believed to correspond to text entry or dictation may be left to a separate module or application.

For example, input data that is determined to potentially provide emotional information by one or more emotion detection modules, may be subsequently analyzed and/or interpreted by text-capable communication application 140 or 170 (either on sender device 102 or recipient device 104), by emotion augmentation module(s) 170 on communication application server 108, or by emotion augmentation module(s) 160 on recipient device 104. In any of these arrangements, the separate modules or applications may receive segments of input data that are identified as providing emotional information (or as potentially providing emotional information) by one or more emotion detection modules 120, and analyze the collective emotional information provided by the one or more emotion detection modules 120, and possibly other data as well, to determine a particular emotion or emotions to associate with a particular portion of typed or dictated text.

In some embodiments, the emotion data that is output from one or more of emotion detection modules 120 may take the form of emotional metadata. The emotional metadata may be output as an emotional metadata stream, which may be sent in conjunction with a text stream or another text-based communication that includes the text data to which the emotional metadata corresponds. In particular, the text stream and emotional metadata stream may both be sent to a recipient device 104 via one or more data networks (and perhaps via a communication application server that routes the text stream and emotional metadata stream to the recipient device).

One or more emotion augmentation modules 160 at the recipient device 104 may use an emotional metadata stream such as described above to augment text that is output via one or more of the recipient device's output interfaces 150. For instance, an emotion augmentation module 160 may add an emoticon representative of received emotional metadata when displaying the correspondingly received text, or may animate an avatar to demonstrate emotions indicated by the emotional metadata, while the corresponding text is displayed. Additionally or alternatively an emotion augmentation module 160 may use the combination of the text stream and the corresponding emotional metadata stream to provide an emotionally augmented speech communication via one of the recipient device's output interfaces 150 (e.g., by adjusting speech output from a text-to-speech processor with inflections indicated by emotional metadata). The emotion augmentation modules 160 of the recipient device 104 may also utilize received text and emotion data to emotionally augment the manner in which communications that are displayed, played out, or otherwise presented to a user of the recipient device 104.

Note that while emotion augmentation modules 160 are shown in FIG. 1 as being separate from the recipient device's text-capable communication application 170, one or more of the emotion augmentation modules 160 may in fact be part of text-capable communication application 170, or part of another communication application implemented on the recipient device.

In a further aspect, a communication application server 108 may also include emotion augmentation modules 170, in addition or in the alternative to the emotion augmentation modules 160 that may be provided by the recipient device. The server's emotion augmentation module(s) 170 may provide similar functionality as described above in reference to emotion augmentation modules 160, except that the emotion augmentation module(s) 170 are implemented at the server 108, to provide such emotional augmentation functionality on behalf of the recipient device.

Further, while not shown explicitly emotional detection modules which are similar to or the same as, emotional detection modules 120, may additionally or alternatively be implemented in an application server 108 and/or in a recipient device 104. In such an embodiment, the sender device 120 may send raw data from input device, or provide some pre-processing to send text and/or audio data to the application server 108 and/or to the recipient device 104 for processing by emotion detection modules that are implemented at the application server 108 and/or recipient device 104.

Referring back to sender device 102, in some implementations, an emotion detection module 120 may go beyond acting is a filter for input data that potentially provides emotional information. For example, an emotion detection module could determine a specific emotion or a set of emotions that is or are determined by the module based only on the data it receives. In such an embodiment, an emotion detection module 120 may include the same or similar functionality as described in reference to emotion augmentation module(s) 160. Additionally or alternatively, in the case where multiple emotions are associated with the same text, there may be a further component, such as communication application 140 on the sender device 102, emotion augmentation module(s) 170 on a communication application server, or emotion augmentation module(s) 170 on recipient device 160, which reconciles the multiple associated emotions.

In a further aspect, note that emotional data and/or emotional context that corresponds to text, could be derived from same input data (that is provided by the same input device) as that which provides the text for a text-based communication. For instance, a text message may be generated based on speech-to-text processing of the same speech audio data that is analyzed by an emotion detection module 120 for inflections, tone, phrasing, and/or volume that provide emotional data corresponding to the speech (and thus the text). Additionally or alternatively, the emotional data and/or emotional context for certain text corresponding to certain text could be derived from different input data (possibly provided by different input devices) than that which provides the text. For instance, a text message may be generated using a keyboard interface, while the corresponding emotional data may be derived from image data capturing a user's facial expressions while they are entering the text on the keyboard. Other examples are also possible.

III. Detecting Emotion Data Associated with Input for a Text Communication

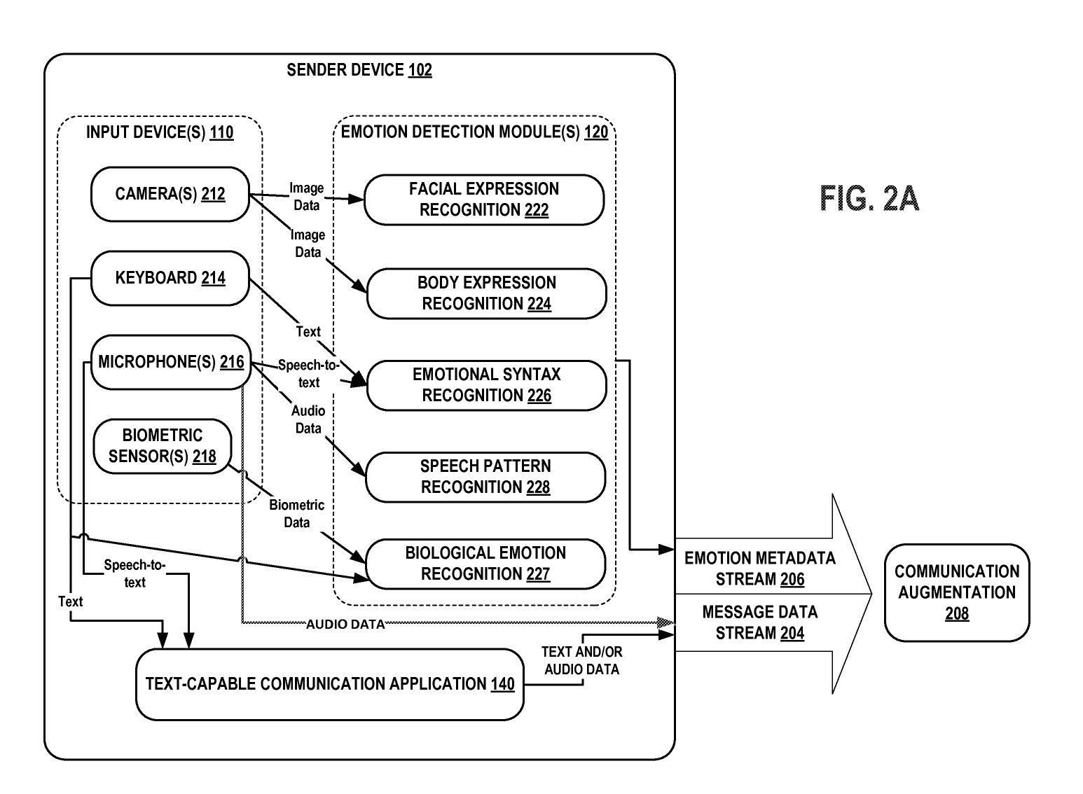

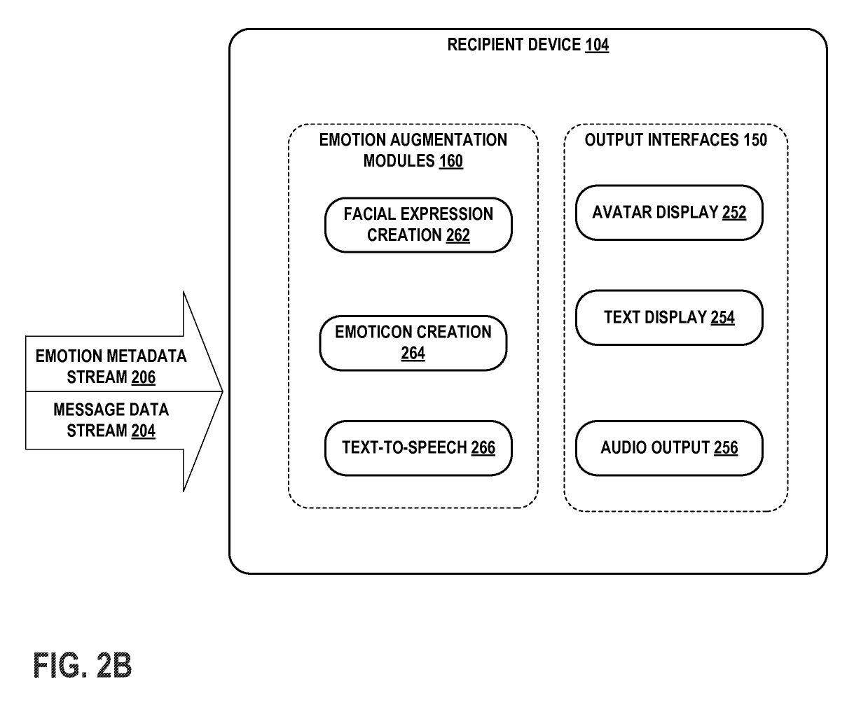

FIG. 2A is a functional block diagram illustrating devices, systems, and functional components, in which example embodiments may be implemented. In particular, FIG. 2A shows the sender device 102 that was illustrated in FIG. 1 in greater detail. As noted above, sender device 102 includes various input devices 110, which may be operable to receive user input and/or to capture emotional information. As further noted above, the sender device 102 also includes various emotion detection modules 120, which may be capable of analyzing input data received via input devices 110 to detect emotion information corresponding to the user's emotional state while providing the input data via input devices 110. Output data from one or more emotion detection modules 120 may be used to generate an emotion data stream 206 that provides emotional information corresponding to message data stream 204.

A. Input Devices

Referring now to input devices 110, the illustrated sender device 102 may include a camera 212 (or possibly multiple cameras), a keyboard 214 (e.g., a physical keyboard and/or software for providing a keyboard interface on a touchscreen), a microphone 216 (or possibly multiple microphones), and one or more biometric sensors 218 (e.g., a heart-rate monitor, a sweat sensor, and/or a pressure-sensitive touchscreen or touchpad, among other examples). It should be understood that a sender device may include more or less input devices than shown in FIG. 2A. A sender device could also include other input devices in combination with, or instead of, one or more of the input devices 110 shown in FIG. 2A.

In a further aspect, a communication application 140 implemented on sender device 102 could automate the process of obtaining input data from input devices 110 for purposes of emotional analysis, and/or of detecting emotion data, so that the user need not provide any additional input to indicate when emotion data should be captured in conjunction with their input for a text-based communication. For example, when the user begins provide input for text generation (e.g., by typing on a keyboard or dictating through a speech-to-text interface), communication application may automatically instruct a camera 212 and/or a biometric sensor 218 to start acquiring and providing image data and/or biometric data, respectively, among other possibilities.

Further, communication application 140 may respond to textual input provided via a keyboard 214 or a microphone 216 by automatically utilizing, coordinating with, or instructing one or more emotion detection modules 120 to generate emotional data corresponding to the text. Yet further, communication application 140 may automatically generate timing data coordinating text and emotion metadata such that a text stream can be time-coordinated with an emotional metadata stream, and/or such that the sender device can send a single text data stream including both text and corresponding emotional metadata. Note also that such automated functionality may be provided by other applications (not shown) on sender device 102, by one or more of the emotion detection modules 120, and/or by other modules and/or components of a sender device.

B. Emotion Detection Modules

Referring now to emotion detection modules 120, the illustrated sender device 102 may include a facial expression recognition module 222, a body expression recognition module 224, an emotional syntax recognition module 226, biological emotion recognition module 227, and a speech pattern recognition module 228. It should be understood that a sender device may include more or less emotion detection modules than shown in FIG. 2A. A sender device could also include other types of emotion detection modules in combination with, or instead of, one or more of the emotion detection modules 120 shown in FIG. 2A.

Facial expression recognition module 222 may receive image data captured by one or more camera(s) 212. Such image data may include one or more still images and/or video that includes a user's face. The facial expression recognition module 222 may analyze such image data to detect facial expressions that are indicative of certain emotions. For instance, the facial expression recognition module 222 may detect emotion by analyzing the shape and/or position of a user eye or eye's (e.g., how open or closed the eye(s) are), and/or by analyzing the position of the user's mouth (e.g., smiling, frowning, or neither). Additionally or alternatively, facial expression recognition module 222 could detect wrinkles at the side(s) the user's eye(s), on the user's forehead, at the sides of the user's mouth, and/or elsewhere, and use the presence, extent, and/or lack of such wrinkles to help determine a user's emotional state. Facial expression recognition module 222 could also utilize other techniques, in addition or in the alternative to those describes herein, to help determine a user's emotional state from image data of a user's face while the user is inputting text or speech for a text-based communication (or possibly shortly before or shortly after inputting such text or speech).

Body expression recognition module 224 may also receive image data captured by one or more camera(s) 212. Such image data may include one or more still images and/or video that includes a portion of the user's body (e.g., the upper half of the user's body), and possibly the entirety of the user's body. The body expression recognition module 224 may analyze such image data to detect “body language” that is indicative of certain emotions; certain gestures, movements, and/or positioning of the body or portions thereof, which is characteristic of certain emotions. For instance, certain hand gestures, head movements, arm movements, whole-body movements, and/or stances, may be considered to be indicative of certain emotional states. Accordingly, when such a gesture, movement, and/or positioning is detected, body expression recognition module 224 may generate emotion data that is indicative of the emotion or emotions associated with the detected gesture, movement, and/or positioning. Body expression recognition module 224 could also utilize other techniques, in addition or in the alternative to those describes herein, to help determine a user's emotional state from image data of the user that is captured while the user is inputting text or speech for a text-based communication (or possibly shortly before or shortly after inputting such text or speech).

Note that when body expression recognition module 224 and facial expression recognition module 222 are utilized concurrently, body expression recognition module 224 may utilize the same image data as, or different image data from, that which is utilized by facial expression recognition module 222. Further, the image data that is provided to body expression recognition module 224 may be captured by the same camera or cameras, or by a different camera or cameras, than the image data provided to facial expression recognition module 222.

Emotional syntax recognition module 226 may receive text that is inputted via keyboard 214, or that is output from a speech-to-text module (not shown) that processes audio data from microphone(s) 216. Emotional syntax recognition module 226 may analyze the text to determine the “plain emotional meaning” of text. In other words, emotional syntax recognition module 226 may analyze the meaning of the words themselves, and determine what emotion or emotions appropriately characterize the words, in the absence of any other emotional information. For example, when emotional syntax recognition module 226 analyzes the text “I'm angry with you,” it may determine that this text corresponds to “anger” and/or “being upset.” As such, emotional syntax recognition module 226 may also be thought of as determining literal information.

Despite the fact that a text message's plain emotional meaning can often be readily understood by a recipient, the information provided by syntax recognition module 226 may none-the-less be useful. More specifically, the plain emotional meaning of text may be informative when analyzed in conjunction with emotional information provided by one or more other emotion detection modules 120.

For example, consider a scenario where a user's face is determined to be “expressionless” by facial expression recognition module 222, and where no emotional information can be derived by other emotion detection modules 120, then it may be inferred that the plain emotional meaning is in fact the emotional meaning that should be associated with the text. In such case, emotion data that is output from syntax recognition module 226 may be inserted into the emotion data stream 206 and associated with the corresponding text in message data stream 204. In other cases, the plain emotional meaning may be analyzed in combination with other emotional information that is identified by other emotion detection modules 120, in order to provide a more refined indication of emotional state. And, in other cases, the plain emotional meaning indicated by syntax recognition module 226 may be ignored or disregarded, such as when the emotion data generated for certain text by other emotion detection modules 120 is counter to, or considered to be more reliable than, the plain emotional meaning of the text itself.

Turning now to biological emotion recognition module 227, this module may receive biometric data from one or more biometric sensors 218. Such biometric data may include, for example: (a) heart rate data from a heart-rate monitor, (b) data indicating an amount and/or location of perspiration from a sweat sensor, (c) eye tracking data from an eye tracking system (e.g., gaze tracking system) indicative of the positioning of one or both eyes, movement of one or both eyes, and/or eye gestures such us winks, voluntary blinks, and/or involuntary blinks, and/or (d) pressure information related to typing text on a pressure-sensitive touchscreen or using pressure-sensitive buttons on a standard mechanical keyboard, among other possibilities. The biological emotion recognition module 227 may analyze such biometric data to detect biological processes and/or biological signs that are indicative of certain emotions.

For example, the biological emotion recognition module 227 may detect an emotion such as excitement or anger based at least in part on a higher than normal heart rate while typing or dictating text for a computer-based communication. As another example, biological emotion recognition module 227 may detect an emotion such as nervousness based at least in part on data from a sweat sensor indicating an increase in perspiration while typing or dictating text for a computer-based communication. As a further example, based at least in part on eye-tracking data corresponding to the user gazing off into space while typing or dictating text, biological emotion recognition module 227 generate emotional metadata indicating that the user was in a pensive state of mind during the text entry.

As yet another example, biological emotion recognition module 227 may analyze the amount of pressure a user applies to a touchscreen when typing on the touchscreen, and output data identifying text that is entered with higher than typical amounts of pressure as emotional information. Such emotional information may be indicative of, e.g., a user typing with more force than is typical due to an emotion such as anger or excitement. Additionally or alternatively biological emotion recognition module 227 (or perhaps a separate behavioral emotion detection module not shown in FIG. 2A) may detect behavioral information corresponding to text entry on a keyboard, which is provides emotional information. For example, if a user types faster or slower than they typically do, this may be identified as emotional information, which may be indicative of an emotional state such being excited (when typing faster), or being relaxed (when typing slower). Other examples are also possible.

Referring now to speech pattern recognition module 228, this module may receive audio data from one or more microphones 216. Speech pattern recognition module 228 may detect speech in the audio data, and may analyze the speech to detect characteristics of the speech that may be indicative of a users emotional state. For example, speech pattern recognition module 228 may detect the inflection, cadence, and/or tone of speech. Other characteristics of speech may also be determined and/or identified as providing emotional information. Further, speech pattern recognition module 228 may output emotional metadata identifying the particular inflections, cadence, and/or tone(s) that are detected in speech. Yet further, speech pattern recognition module 228 might output timing data that is usable at a later time to re-associate the inflections, cadence, and/or tone(s) that are detected in the speech with text that was generated from the speech.

Note that while FIG. 2A shows emotion detection modules 120 as being part of the sender device, some or all of emotion detection modules 120 and/or other types of emotion detection modules may also be implemented elsewhere, by other entities, such as an application server or even a recipient device. In such implementations, sender device 102 may send raw data from input devices 110 to the entity that includes an emotion detection module, to facilitate extraction of emotional information by the other entity.

IV. Augmentation of Text with Emotional Metadata at Recipient Device

FIG. 2B is another functional block diagram illustrating devices, systems, and functional components, in which example embodiments may be implemented. In particular, FIG. 2B shows, in greater detail, the example recipient device 104 that was illustrated in FIG. 1.

As noted above, the recipient device 104 also includes output interfaces 150, which may be operable to display, play out, or otherwise present emotionally augmented communications to a user of the recipient device 104. As further noted above, recipient device 104 may include various emotion augmentation modules 160, which may be operable to use emotion data captured in conjunction with the typing or dictation of a text communication received from a sender device 102 to generate emotionally augmented communications.

In a further aspect, recipient device 104 may receive a message data stream 204 and a corresponding emotional metadata stream 206 that are sent from a sender device. (Note that because text and corresponding emotion data may be sent in other formats, text and corresponding emotional data may also be received in other formats by a recipient device.) The message data stream 204 may include, e.g., text that is entered via a keyboard at the sender device and/or text generated via application of a speech-to-text process to speech input provided by a microphone at the sender device. The message data stream 204 may additionally or alternatively include audio data that is captured by a microphone, and perhaps has undergone some processing before transmission in the data stream. The emotional metadata stream 206 may include emotion data that is generated by, or derived from the output of, facial expression recognition module 222 and/or other emotion detection modules 120.

In a further aspect, message data stream 204 and/or emotional metadata stream 206 may include timing data that associates the text stream, or portions thereof, with the emotional metadata, or corresponding portions thereof. The recipient device 104 may use such timing to, e.g., coordinate the display or augmentation of text so that the timing with which emotional information is provided via output interfaces 150 is indicative of the timing relationship between detection of the emotional information and entry or dictation of the text at the sender device. Alternatively, message data stream 204 and/or emotional metadata stream 206 may in fact be provided as a single data stream, which includes both text and corresponding emotional metadata. In this case, the manner in which the metadata is provided in the text stream may itself be indicative of a timing relationship between the emotion metadata and corresponding text in the text stream.

A. Output Interfaces

Referring now to output interfaces 150, the illustrated recipient device 104 may include an avatar display interface 252, a text display interface 254, and an audio output interface 256. The avatar display interface 252 and/or the text display interface 254 may be presented on a graphic display (not shown) of the recipient device 104, while the audio output interface 256 may be provided using one or more speakers (not shown) that are integrated in or connected to the recipient device 104. It should be understood that a recipient device may include more or less output interfaces than shown in FIG. 2B. A recipient device could also include other types of output interfaces in combination with, or instead of, one or more of the output interfaces 150 shown in FIG. 2B.

Note that in some embodiments the avatar display interface 252 may additionally or alternatively include a physical representation of a face and/or body. For example, avatar display interface 252 may include a robotic face and/or humanoid robotic body parts, which may be operated to move in ways that are representative of certain emotions. Other examples are also possible.

B. Emotional Augmentation

As shown, the emotional augmentation modules 160 of recipient device 104 include a facial expression creation module 262, an emoticon creation module 264, and a text-to-speech module 266. It should be understood that a recipient device may include more or less emotion detection modules than shown in FIG. 2B. A sender device could also include other types of emotional augmentation modules in combination with, or instead of, one or more of the emotional augmentation modules 160 shown in FIG. 2B.

Facial expression creation module 262 may receive emotion data via emotion metadata stream 206 and/or other sources. Such emotion data may be generated by, or derived from the output of, facial expression recognition module 222 and/or other emotion detection modules 120. Such emotion data may be indicative of certain emotions and/or of facial expressions corresponding to received emotion data (e.g., to emotion metadata stream 206 or a portion thereof). Accordingly, facial expression creation module 262 may use such received emotion data, perhaps in conjunction with timing data that coordinates the emotion data with corresponding text, to animate an avatar (e.g., a graphic or cartoon-like representation of a person's face, and possibly other portions of the body as well). For instance, facial expression creation module 262 may generate animations of an avatar, or output data from which such animations can be generated, which are recognizable as expressing an emotion or emotions indicated by the received emotion data. The animations of the avatar may by displayed in avatar display interface 252, along with the text to which the emotional animations correspond. The text may be displayed all at once, or over time, so that changes in emotional context shown demonstrated by the avatar correspond to changes in emotional context during the entry of the corresponding text at the sender device. Ala

In order to provide animations that are indicative of various emotions, facial expression creation module 262 may generate animations, or output data from which such animations can be generated, in which: (a) the avatar's eyes and/or eyebrows move, (b) the shape and/or position of the avatars eye or eye's changes (e.g., the avatar's eyes may open or close, and/or change direction to help demonstrate various emotions), (c) the avatar's mouth moves at various rates and into various positions (e.g., smiling, frowning, or neither), (d) wrinkles form, move, and change size at the side(s) the user's eye(s), on the user's forehead, at the sides of the user's mouth, and/or elsewhere on the user's face. Other types of animations may also be used to demonstrate various emotions via an avatar, in addition or in the alternative to those described herein.

Emoticon creation module 264 may receive may receive emotion data via emotion metadata stream 206 and/or other sources. Such emotion data may be generated by, or derived from the output of, one or more emotion detection modules 120, and may be indicative of certain emotions corresponding to certain received text. For example, an emoticon creation module 264 may add one or more emoticons, which is or are representative of received emotional metadata, when displaying the correspondingly received text via text display interface 254. Other examples are also possible.

Text-to-speech module 266 may receive text via message data stream 204 and/or from other sources, and may output audio data that includes computer generated or pre-recorded speech corresponding to the received text. Further, text-to-speech module 266 may receive may receive emotion data via emotion metadata stream 206 and/or via other sources. Such emotion data may indicate characteristics of the human voice from which the received text was originally generated (e.g., via speech-to-text processing at sender device 102). For example, such emotion data may indicate characteristics of the original human speech such as inflections, tone, phrasing, and/or volume, which can be indicative of the emotional state of the speaker.

Text-to-speech module 266 may use emotionally significant speech characteristics that are indicated by emotion metadata stream 206 to provide computer-generated speech with characteristics that correspond to or simulate those of the original human speech from which the corresponding text was derived. For instance, the computer-generated speech may simulate speech characteristics such as inflection, tone, phrasing, and/or volume, which correspond to or simulate those of the original human speech from which the received text was derived. Alternatively, a separate module or application (not shown) may receive computer-generated speech that is generated by text-to-speech module 266, and apply processing to modify the computer-generated speech with emotionally significant characteristics of the original human speech, such as inflections, tone, phrasing, and/or volume, among other possibilities.

In a further aspect, a communication application 170 implemented on recipient device 104 could automate the process of emotionally augmenting communication data for display, play out, or presentation via one or more of output interfaces 150, so that the user of the recipient device need not provide any additional input to receive emotionally augmented communications from emotional augmentation modules 160. Alternatively, user settings may be provided that allow a user of the recipient device to specify how and/or when incoming communications should be emotionally augmented by one or more of the emotional augmentation modules 160.

### V. Example Methods for Emotion Augmentation of Computer-Based Communication

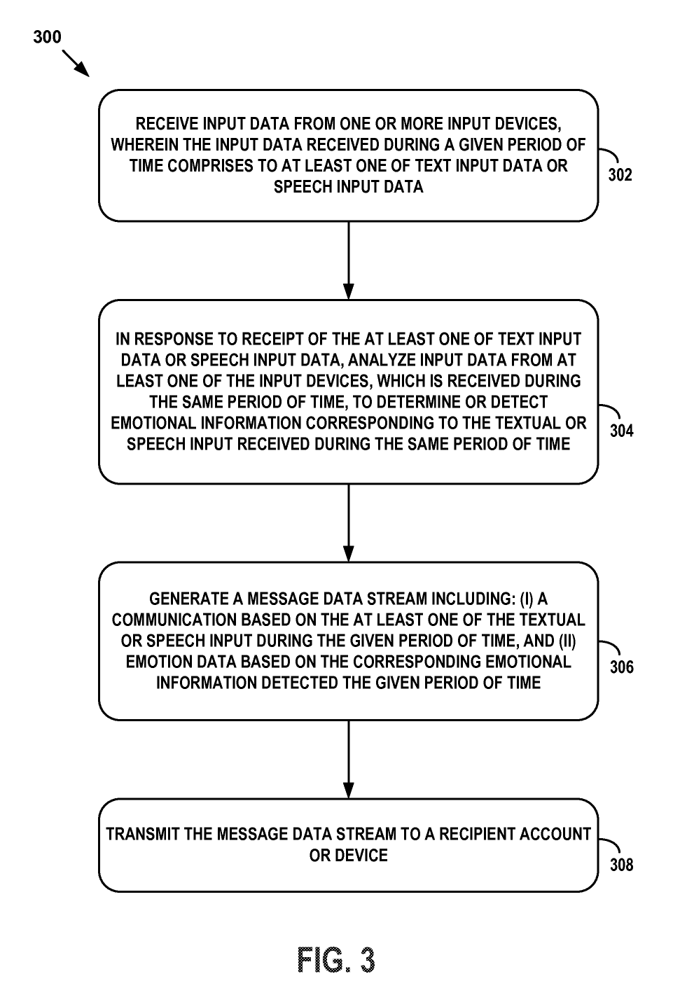

FIG. 3 is a flow chart illustrating a method 300 according to an example embodiment. Example methods, such as method 300, may be carried out in whole or in part by various computing devices or combinations of computing devices, such as by a sender device, a recipient device, an application server, or a combination of two or more of these devices. However, for explanatory purposes, the description below may simply refer to portions of method 300 as being carried out by a computing device. However, it should be understood that method 300 or portions thereof may be carried out various other devices or combinations of other types of devices, without departing from the scope of the invention.

As shown by block 302, method 300 involves a computing device (e.g., a sender device), receiving input data from one or more input devices of a computing device, wherein the input data received during a given period of time comprises to at least one of text input data or speech input data. For example, at block 302, a sender device 102 may acquire input data from one or more of input devices 110. Other examples are also possible.

In response to receipt of the at least one of text input data or speech input data, the computing device analyzes input data from at least one of the input devices, which is received during the same period of time, to determine or detect emotional information corresponding to the textual or speech input received during the same period of time, as shown by block 304. For example, one or more emotion detection modules 120 and/or communication application 140 may execute processes to detect emotional information in, or derive emotional information from, input data that is acquired via one or more of input devices 110.

The computing device may then generate a message data stream comprising: (i) a communication based on the at least one of the textual or speech input during the given period of time, and (ii) emotion data based on the corresponding emotional information detected the given period of time, as shown by block 306. Further, the computing device may transmit the message data stream to a recipient account or device, as shown by block 308. For example, at block 308, a sender device may transmit text and/or audio data in a message data stream 204 and a separate, time-coordinated, emotional metadata stream 206. Alternatively, the message data stream may a single data stream, which includes both text and corresponding emotional metadata. Other formats for the message data stream or streams are also possible.

V. Example Computing Devices

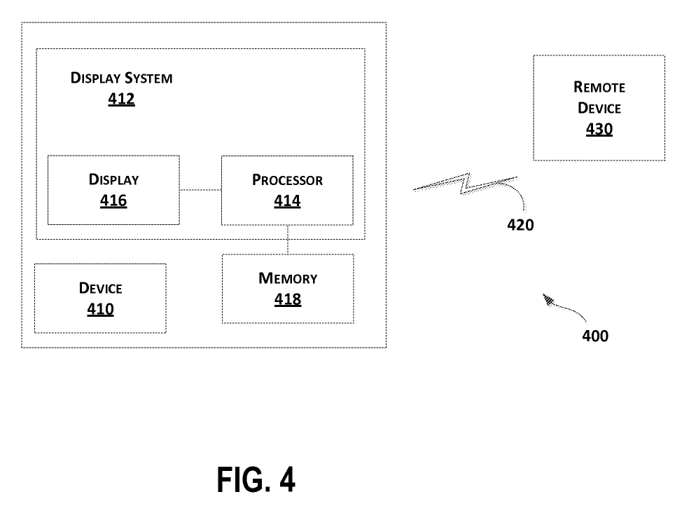

FIG. 4 is a simplified block diagram of a computing device according to an example embodiment. In an example embodiment, device 410 communicates using a communication link 420 (e.g., a wired or wireless connection) to a remote device 430. The device 410 may be any type of computing device that can receive data and/or display information corresponding to or associated with the data. Examples of a computing device 410 include sender device 102, recipient device 104, and/or application server 108, among other possibilities.

The device 410 may include a processor 414 and a display 416. The display 416 may be, for example, an optical see-through display, an optical see-around display, or a video see-through display. The processor 414 may receive data from the remote device 430, and configure the data for display on the display 416. The processor 414 may be any type of processor, such as a micro-processor or a digital signal processor, for example.

The device 410 may further include on-board data storage, such as memory 418 coupled to the processor 414. The memory 418 may store software that can be accessed and executed by the processor 414, for example.

The remote device 430 may also be any type of computing device, and may be the same type or a different type of device than computing device 410. For instance, if computing device 410 is functioning as a sender device, then the remote device 430 may be an application server or recipient device, and, if computing device 410 is functioning as a recipient device, then the remote device 430 may be an application server or sender device. Other examples are possible. Further, the remote device 430 and the device 410 may contain hardware to enable the communication link 420, such as processors, transmitters, receivers, antennas, etc.

Further, remote device 430 may take the form of or be implemented in a computing system that is in communication with and configured to perform functions on behalf of client device, such as an application server 108. Such a remote device 430 may receive data from another computing device 410, such as sender device 102 and/or recipient device 104, may perform certain processing functions on behalf of the device 410, and may then send the resulting data back to device 410 or on to a different device. This functionality may be referred to as “cloud” computing.

In FIG. 4, the communication link 420 is illustrated as a wireless connection; however, wired connections may also be used. For example, the communication link 420 may be a wired serial bus such as a universal serial bus or a parallel bus. A wired connection may be a proprietary connection as well. The communication link 420 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 430 may be accessible via the Internet and may include a computing cluster associated with a particular web service (e.g., social-networking, photo sharing, address book, etc.).

### VI. Conclusion

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Herein, a “module” should be understood to be software, hardware, and/or firmware that is configured to provide the described functionality. As such, a module may include program instructions, logic, or code, which is stored on a non-transitory computer readable medium and executable by a processor, to provide the functionality that is attributed to the module herein, and possibly other functionality as well. A module may also include certain communication interfaces and input device interfaces. Further, a module may include certain sensors or sensing devices.

In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a computing system. Such a computing system may include various computing devices or components thereof, such as a processor or microprocessor for implementing specific logical functions or actions in the method or technique.

Moreover, a step or block that represents one or more information transmissions may correspond to information transmissions between software and/or hardware modules in the same physical device. However, other information transmissions may be between software modules and/or hardware modules in different physical devices.

In the embodiments described herein and others, program instructions, logic, or code and/or related data may be stored on any type of computer-readable medium, including non-transitory computer-readable media such as a storage device, including a disk drive, a hard drive, or other storage media. The computer-readable medium may include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

1. A computing device comprising:
a communication interface;
a plurality of input devices comprising a camera;
at least one processor;
a plurality of emotion detection modules, wherein each emotion detection module comprises program instructions stored on a non-transitory computer readable medium and executable by the at least one processor, wherein the plurality of emotion detection modules comprises an emotional syntax recognition module operable to determine plain emotional meaning of a text or voice message, and a facial expression recognition module operable to determine emotional information based on image data from the camera; and
program instructions stored on a non-transitory computer readable medium and executable by the at least one processor to:
receive input data comprising to at least one of text input data or speech input data from one or more of the input devices, wherein the input data comprising at least one of text input data or speech input data is received during a given period of time;
in response to receipt of the at least one of text input data or speech input data, use one or more of the emotion detection modules to analyze input data received from at least one of the one or more input devices, during the given period of time, to detect emotional information corresponding to the textual or speech input received during the given period of time;
generate a message data stream comprising (i) a communication based on the at least one of the textual or speech input during the given period of time, and (ii) emotion data based on the corresponding emotional information the given period of time; and
operate the communication interface to transmit the message data stream.

2. The computing device of claim 1, wherein the one or more input devices comprise one or more of the following input devices: (a) a camera, (b) a mechanical keyboard interface, (c) a touchscreen, (d) a microphone, and (e) one or more biometric sensors.

3. The computing device of claim 1, wherein the one or more input devices comprise a facial expression recognition module that is executable to detect emotional information in image data captured by a camera of the computing device.

4. The computing device of claim 1, wherein the one or more input devices comprise a body expression recognition module that is executable to detect emotional information in image data captured by a camera of the computing device.

5. The computing device of claim 1, wherein the one or more input devices comprise an emotional syntax recognition module that is executable to detect the plain emotional meaning of text provided via one or more of the input devices.

6. The computing device of claim 1, wherein the one or more input devices comprise a biological emotion recognition module that is executable to detect emotional information in image data captured by one or biometric sensors that are communicatively coupled to the computing device.

7. The computing device of claim 1, wherein the one or more input devices comprise a speech pattern recognition module that is executable to detect emotional information in audio data comprising speech.

8. The computing device of claim 1, further comprising:
one or more emotion augmentation modules, wherein each emotion augmentation module comprises program instructions stored on a non-transitory computer readable medium and executable by the at least one processor; and
program instructions stored on a non-transitory computer readable medium and executable by the at least one processor to:
receive the message data stream comprising emotional information;
use one or more of the emotion augmentation modules to generate an emotionally augmented communication based on the emotional information and the at least one of the textual or speech input; and
transmit the emotionally augmented communication via at least one of the output devices, to a recipient device.

9. A computing device comprising:
a communication interface;
one or more output devices;
at least one processor;
one or more emotion augmentation modules, wherein each emotion augmentation module comprises program instructions stored on a non-transitory computer readable medium and executable by the at least one processor;
program instructions stored on a non-transitory computer readable medium and executable by the at least one processor to:
receive a message data stream comprising (i) a communication based on at least one of the textual or speech input at another computing device during the given period of time, and (ii) emotion data indicative of emotional information corresponding to receipt of the textual or speech input at another computing device, during the given period of time, wherein the emotion data comprises (a) data indicating a plain emotional meaning of the textual or speech input, and (b) data indicating facial-expression emotional information determined from facial image data corresponding to the textual or speech input;
use one or more of the emotion augmentation modules to generate an emotionally augmented communication based on the emotion data and the received communication based on at least one of the textual or speech input; and
output the emotionally augmented communication via at least one of the output devices.

10. The computing device of claim 9, wherein the one or more output devices comprise one or more of the following output devices: (a) an avatar display interface, (b) a text display interface, and (c) an audio output interface.

11. The computing device of claim 9, wherein the one or more emotion augmentation modules comprise one or more of the following emotion augmentation modules: (a) a facial expression creation module, (b) an emoticon creation module, and (c) a text-to-speech module.

12. A method comprising:
receiving, by a computing device, input data from one or more input devices of the computing device, wherein the input data received during a given period of time comprises to at least one of text input data or speech input data;
determining a plain emotional meaning of the text or speech input data;
in response to receiving the at least one of text input data or speech input data, the computing device analyzing input data received from at least one of the one or more input devices, during the same period of time, to detect emotional information corresponding to the textual or speech input received during the same period of time, wherein the analyzing of the input data comprises applying a facial expression recognition process to image data from a camera to detect the emotion information therefrom;
generating a message data stream comprising (i) a communication based on the at least one of the textual or speech input during the given period of time, and (ii) emotion data based on the plain emotional meaning of the text or speech input data and the corresponding emotional information provided by the facial expression recognition process; and
transmitting the message data stream to a recipient account.

13. The method of claim 12, wherein the message data stream further comprises timing data that correlates the communication based on the at least one of the textual or speech input with the corresponding emotional information.

14. The method of claim 12, wherein input data is received from a plurality of input devices comprising at least a first input device and a second input device.

15. The method of claim 12, wherein the plurality of input devices comprise at least a first input device and a second input device, and wherein the input data comprises at least a first modality of input data received from the first input device and a second modality of input data received from the second input device.

16. The method of claim 15, wherein the first input device comprises a microphone, and wherein the input data comprises audio data received from the microphone.

17. The method of claim 12, wherein the one or more input devices comprise an image capture device, and wherein determining the emotional information comprises applying a facial-expression recognition process to image data from the image capture device during the period of time.

18. The method of claim 12, wherein the one or more input devices comprise a microphone, and where determining the emotional information comprises applying an inflection recognition process to audio data generated by the microphone during the period of time.

19. The method of claim 12, wherein the emotion data comprises animation data for an avatar.

20. The method of claim 19, wherein the avatar comprises a graphic face, and wherein the animation data indicates movements of the graphic face that project an emotional state indicated by the determined emotional information.

21. The method of claim 12, wherein the emotion data comprises an emoticon corresponding to the determined emotional information.

22. The method of claim 12, wherein the communication comprises text, and wherein emotion data comprises speech inflection data corresponding to the text.

23. The method of claim 22, wherein the inflection data specifies inflectional processing to be applied by a text-to-speech process when processing the text, such that application of the text-to-speech process to the text generates a computerized speech output having simulated inflections that correspond to the emotional information that was determined to correspond to the speech input.

24. The computing device of claim 1, wherein the program instructions stored on a non-transitory computer readable medium and executable by the at least one processor to use the one or more of the emotion detection modules to analyze input data comprise program instructions stored on a non-transitory computer readable medium and executable by the at least one processor to:
compare the plain emotional meaning of the text or voice message to the emotional information determined by the facial expression recognition module; and
generate the emotion data based on the comparison of the plain emotional meaning to the emotional information determined by the facial expression recognition module.
